(19) United States
(12) Patent Application Publication
(10) Pub. No.: US 2009/0252219 A1
(43) Pub. Date: Oct. 8, 2009

(54) METHOD AND SYSTEM FOR THE TRANSMISSION OF DIGITAL VIDEO OVER A WIRELESS NETWORK

(75) Inventors: Yingwei Chen, Briarcliff Manor, NY (US); Ruediger Schmitt, Maplewood, NJ (US); Richard Chen, Croton on the Hudson, NY (US); Karl Wittig, New York, NY (US); Kiran Challapali, New City, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,830

(22) PCT Filed: Dec. 12, 2005
(86) PCT No.: PCT/IB2005/054189

§ 371 Date: Jun. 15, 2007

Related U.S. Application Data
(60) Provisional application No. 60/636,363, filed on Dec. 15, 2004.

(51) Int. Cl. H04N 11/02

(52) U.S. Cl. 375/240.02; 375/E07.026

(57) ABSTRACT

An apparatus, system and method are provided for adaptive flow control of layered streaming video over wireless local area networks (WLANs). In one aspect prioritised and adaptive transmission mechanisms are provided based on buffer fullness and discarding visually less important packets so that future visually more important packets can reach the decoder in time. In another aspect, aggregated control is provided for all video applications as well as separate control for each video application.

The present invention relates to a method and system for control of digital video transmission over unreliable wireless channels. The present invention also relates to adaptive transmission of data packets in a digital video system.

The transmission of digital video, using a video coding standard such as MPEG, over a wireless network in which the available data bandwidth is less than the data rate of digital video transmitted over the network, typically results in unacceptable degradation of the displayed video.

One approach to adapting digital video to the available bandwidth is to partition a single layer digital video data stream into a multi-layer video stream containing a base layer (BL) and at least one enhancement layer (EL) and then to transmit the layers through a network. BL packets comprise visually important data and EL packets comprise visually less important data. Both BL and EL packets must arrive at a receiver before a pre-determined deadline (which determines maximum tolerable end-to-end delay) in order to reconstitute an image.

Layered video data transmitted over unreliable wireless channels typically encounters reduced capacity of the medium. When the capacity of the wireless medium drops to below the bit-rate of the compressed (layered) video, typical flow control algorithms dictate that some packets must be dropped. That is, any packets that arrive at a receiver after a predetermined delivery deadline are useless. Therefore, it is better to discard these packets without transmitting them in the first place such that the remaining channel bandwidth can be utilized to transmit packets that will arrive at the receiver in time.

Existing approaches to flow control for video data are either too complex or require additional information that might not be available, such as channel state information (CSA). For example, in existing video transmission systems, video content is organized into multiple layers or priority classes, as discussed above. This prioritization information resides in the application layer and need to be conveyed to the lower layers (specifically data link and media access control layers) of communications devices for differentiated transmission. The emerging IEEE 802.11e standard specifies a means, namely, traffic specification or TSPEC, to communicate data traffic flow information to the data link (DL) and medium access control (MAC) layers. However, the implementation of IEEE 802.11e requires multiple queues in a wireless LAN (WLAN) device and modification of the MAC protocol and therefore is possible only with new designs of such devices. Further, many existing WLAN devices or WLAN HW/SW designs cannot be upgraded to support IEEE 80211e.

Finally, while arguably effective, the present signalling mechanism using a proprietary video payload-type specification in an RTP header renders the RTP packet non-compliant with the RTP specification. Moreover, it works only in a point-to-point communication scenario. It is desirable that this signalling is performed per communication session or flow rather than per packet to reduce the amount of overhead and to adhere to a flow-based design principal for lower layers of a communication stack.

The system and method of the present invention provide a prioritized/adaptive flow and layered video stream approach to mitigating the effect of insufficient bandwidth to accommodate the high data rate of digital video. Further, the system and method of the present invention provides the information from the application layer to the DL and MAC layers while keeping the video data packet format compliant with existing communications protocols and various algorithms for differentiated transmission with multiple simultaneous video applications.

The system and method of the present invention provides several alternative embodiments for prioritized transmission control, depending on whether the transmission control is done collectively or separately for each video application transmitting digital video.

The present invention includes a differentiated transmission (unequal error protection or UEP and selective packet dropping based on buffer fullness) algorithm that applies to point-to-point transmission of one video application only. In an adaptive streaming system, such as a layered video streaming system described in the present invention, the priority given to each layer (or similarly, each portion or subset of data) is important to the DL and MAC layers both for UEP and link adaptation purposes. Because each video layer (or video data subset; from this point on “layer” is used to refer to both) is associated with a unique sender/receiver IP address and port pair, an implicit or explicit map of such association is utilized in a preferred embodiment to signal the layering/priority information to the DL and MAC.

In a preferred embodiment, an access point (AP) of a basic service set (BSS) acts as an aggregation point for multiple video applications. The AP has knowledge of all such video traffic and controls the transmission of each video flow using prioritized/adaptive mechanisms and layered signalling for each video application.

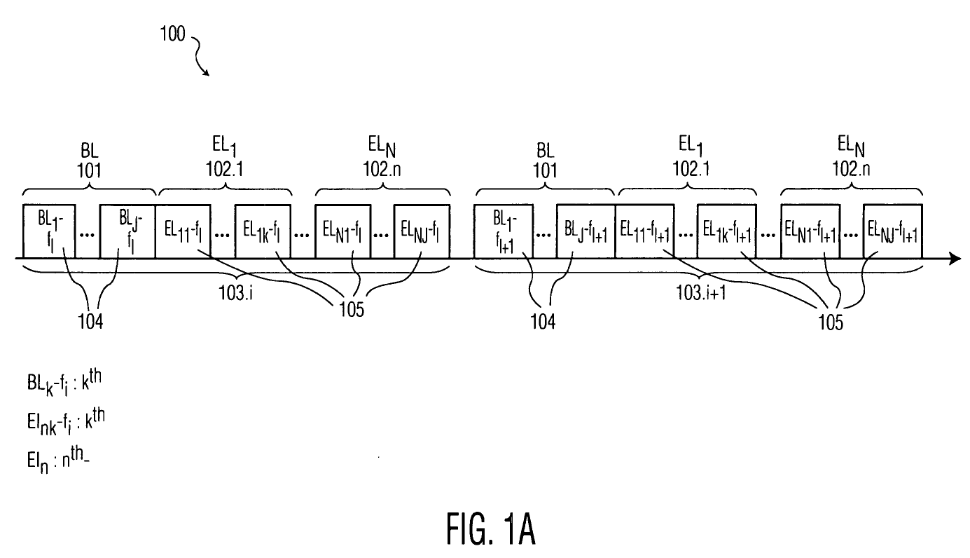

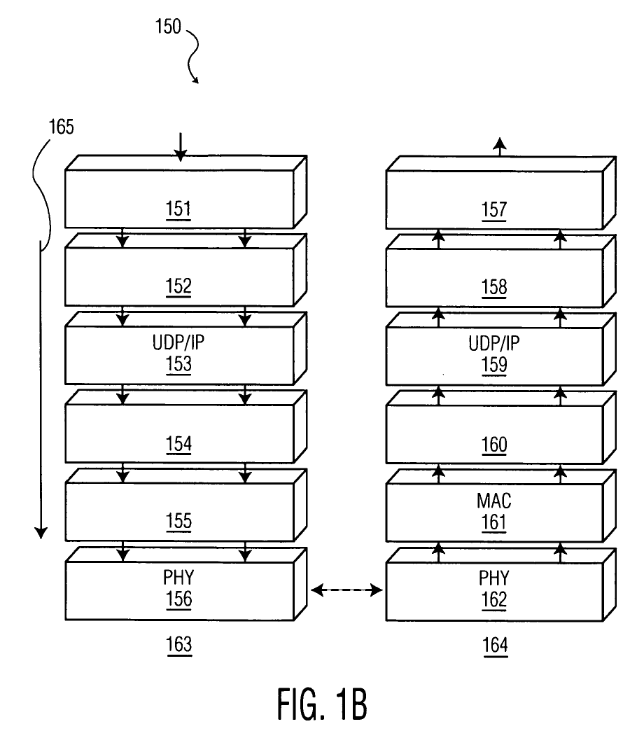

FIGS. 1A-B illustrates the frame-based order of packet transmission for the base and enhancement layers of a multiple-layer digital video sequence;

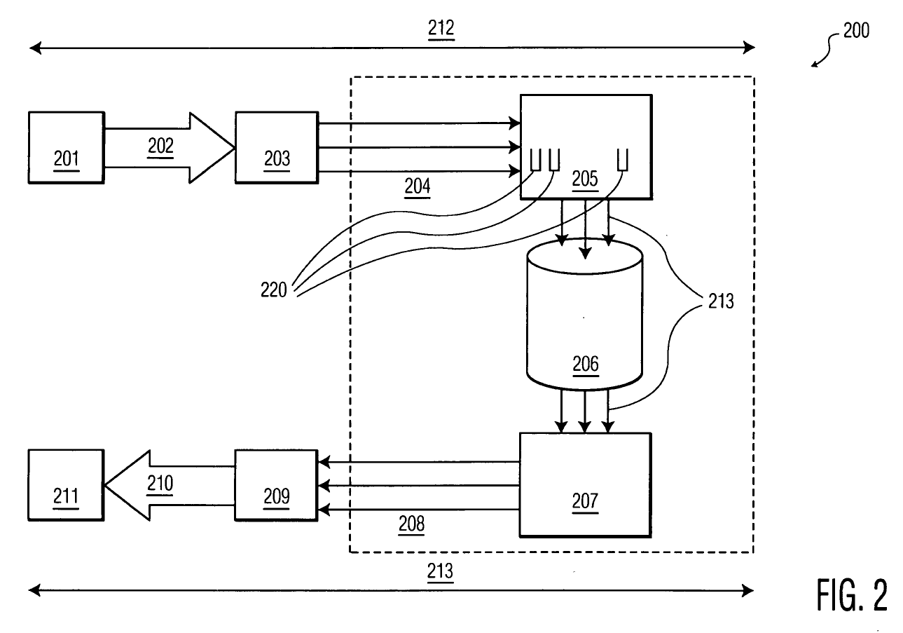

FIG. 2 illustrates shows a conceptual block diagram of a device modified according to the multiple-layer video transmission system of the present invention;

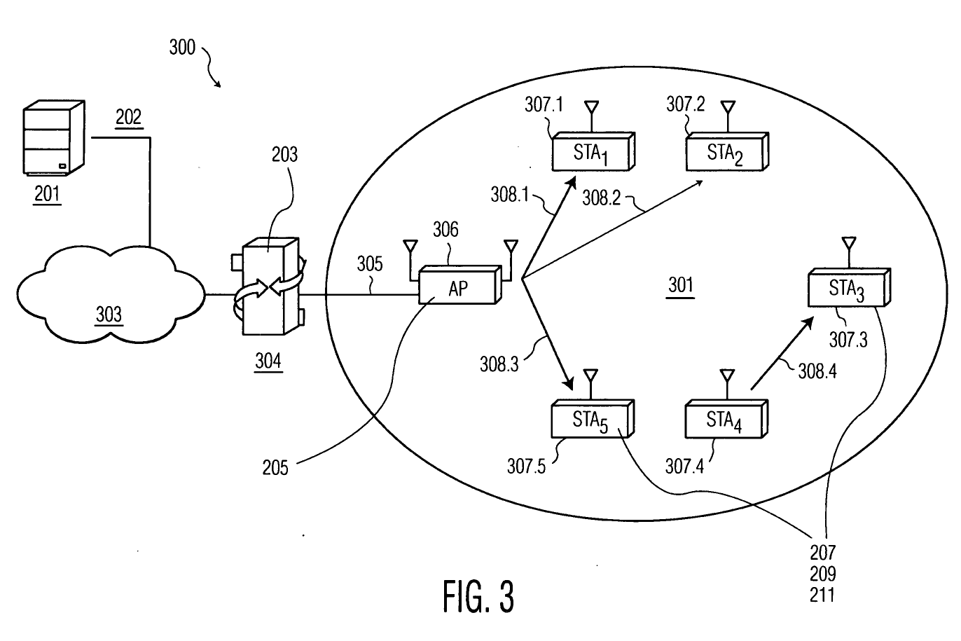

FIG. 3 illustrates a wireless network carrying video and data traffic simultaneously;

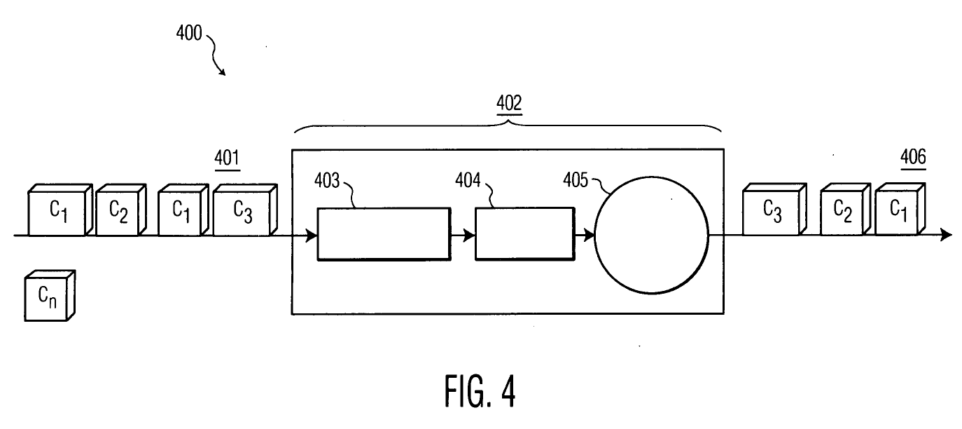

FIG. 4 illustrates a queuing discipline with data traffic comprising different categories;

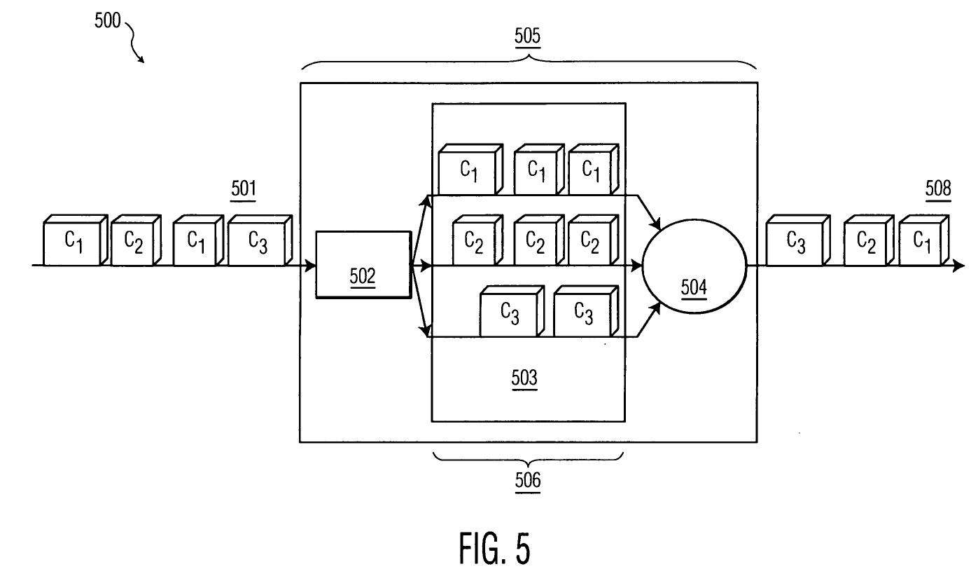

FIG. 5 illustrates priority queuing;

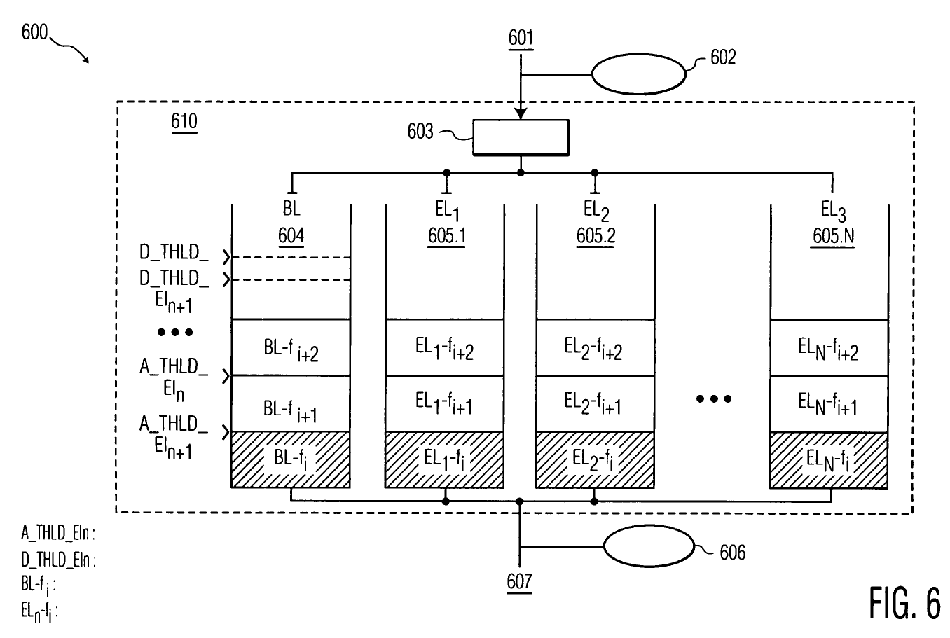

FIG. 6 illustrates a multiple-buffer queuing discipline for layered video streaming;

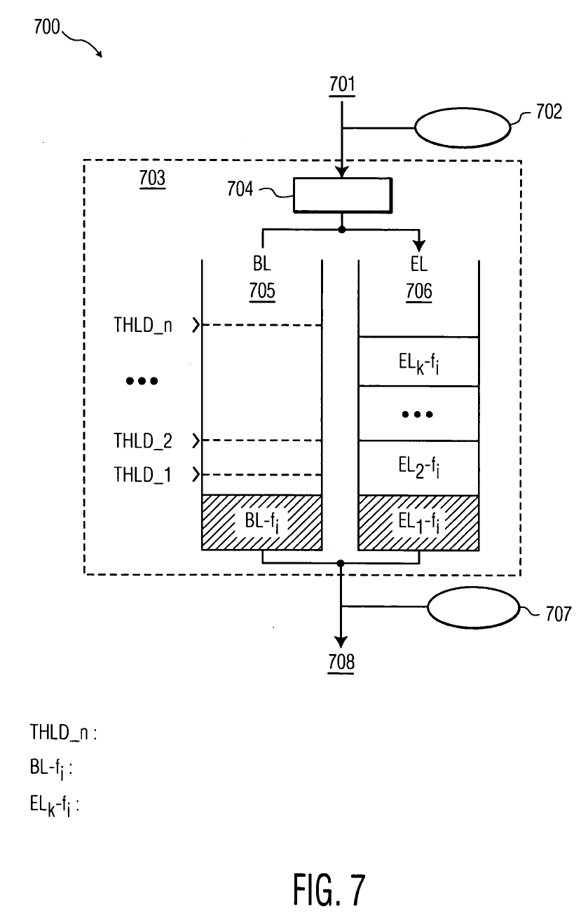

FIG. 7 illustrates a double-buffer queuing discipline for layered video streaming; and

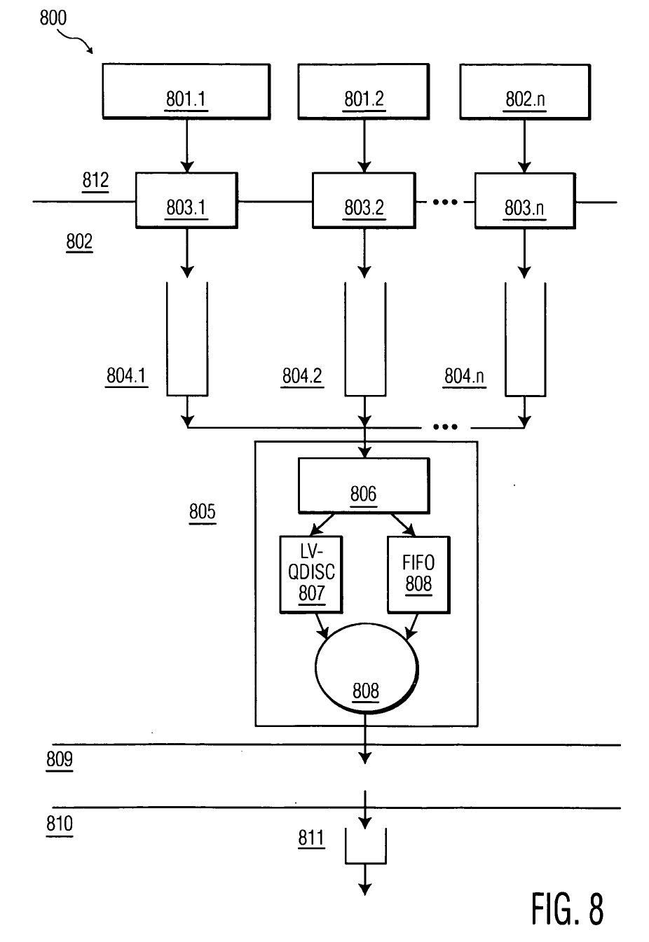

FIG. 8 illustrates an operating system network stack for layered video streaming with concurrent applications.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

The system and method of the present invention provides several alternatives for implementation of digital video packet transmission control, depending on whether the transmission control is done collectively or separately for each video application that is transmitting digital video. These control include:
prioritized and adaptive transmission—
   1. buffer fullness based vs. error statistics based
   2. aggregated vs. separate for each video program
layered signalling.

Aggregated transmission control for each video application is a simpler form of differentiated transmission in which only priority information is used in controlling the transmission process, i.e., the priority of each packet determines how it is transmitted regardless which video application the packet belongs to. An AP 306 can, for example:
apply a different retry limit (the number of times the communication device retransmits a packet until a positive acknowledgement is received) to different priority classes for differentiation;
apply a different transmission rate (the higher being less reliable) to different priority classes; and
drop some enhancement layers packets if the outgoing (transmission) queue exceeds a certain threshold for fullness (indicating imminent queue overflowing and consequently packet losses within the queue) wherein an amount of enhancement layer packets to drop is such that the outgoing queue status is below the overflowing threshold and dropping is performed regardless of the video application each enhancement layer packet is associated with to ensure fairness.

In the aggregated mode of operation, no differentiation is made among the packets within the same priority class, even if they belong to different video applications. This has the advantage of low implementation complexity, however, at the cost of less efficient transmission than more complicated approaches. For example, some video applications may be unfairly penalized if a large number of their enhancement layer packets are dropped. However, this simple differentiated transmission scheme does achieve coarse unequal error protection and channel adaptive transmission.

In one aspect, priority and application dependent transmission with multiple queues, separate queues are maintained for each application. The device driver or firmware keeps track of the status and controls the transmission of each video application separately. There is again a single transmission queue in the communication device.

The device driver or firmware tracks the status of each video application in progress. The dropping or sending of a particular packet not only depends on the queue status and the packet's priority, but also on which video application the packet belongs to, in order to ensure that a fair share of EL packets are dropped for each video application. For this purpose, the device driver records the percentage of dropped packets for each video application. An EL packet of a video application is not dropped if its historical dropping ratio exceeds those of other video applications by a predetermined threshold (e.g., within 20%).

In yet another aspect, the visually less important EL packets are discarded in order to make room for future important BL data, even if the EL packets could reach the decoder in time. A preferred embodiment comprises using fixed end-to-end delay for the BL packets and a shorter deadline (effectively a smaller end-to-end delay) for the EL packets. In this way, transmission of future BL packets is assured at the expense of dropping current EL packets.

Referring now to FIG. 3, the basic building block of an IEEE 802.11 WLAN is a Basic Service Set (BSS) 301, which consists of an Access Point (AP) 306 and a plurality of stations (STA) 307.i. In a typical A/V streaming application, the A/V streaming server 201 (see FIG. 2) can be connected to the AP 306 through a wired connection 305 or serve as the host for the AP directly with a wireless transmitter plugged into the server (not shown). In either case, the AP 306 is the traffic aggregation and control point through which all packets are transmitted over the WLAN BSS 301.

Referring now to FIGS. 1B and 3, in a preferred embodiment of a layered video transmission system, video content is separated into several layers 204 of different importance or priority classes for transmission. At a sender side 163 212, these multiple priority classes are carried in multiple transport sessions (RTP sessions) and sent down the network stack 163 (onto lower layers such as DLL and MAC). The prioritization provides the traffic classification and identification, which can be used in the underlying network layers to perform link or channel adaptation. This type of classification and identification is passed down to the lower network layers via a vertical signalling mechanism 165. The link adaptation algorithm is executed at the link adaptation network layer 154.

The transmission of digital video, using a video coding standard such as MPEG, over a wireless network in which the available data bandwidth is less than the data rate of digital video transmitted over the network typically results in unacceptable degradation of the displayed video. In order to prevent this, a layered video transmission system may be used. The layered video transmission system consists of three components: a splitter 203 and an adaptive scheduler 205 in the transmitter, and a merger in the receiver 209.

First, a prioritization scheme is used to partition the video data into a BL 101 containing the essential information and one or more ELs 102.1-102.n, n≧1, containing the less essential information. Second, in order to maximize the quality of the received video, adaptation takes place in which the BL 101 is always transmitted, whereas some or all of the enhancement layers are “dropped” (i.e., not sent) whenever the available network bandwidth is insufficient for transmission of all of the video data.

Referring now to FIG. 1B, a frame-based order of packet transmission is illustrated for the BL and ELs of a multiple-layer digital video sequence. The multiple video data layers are in turn segmented into data packets 104 105 that are transmitted over the network. Each packet 104 105 is thereby associated, respectively, with either the BL 101 or an EL 102.1-102.n, n≧1. For every video frame 103.i, the packets corresponding to that frame are transmitted contiguously. Typically, all of the BL packets 104 for a given frame are transmitted before the EL packets 105 for that frame. If more than one EL 105 is used, packets are transmitted in decreasing order of priority of the EL 105 to which they belong. This is done to insure that the higher-priority packets are the most likely to be sent and received. This ordering is repeated for every successive video frame 103.i.

It is envisioned that, in the future, data, voice, and audio/video traffic will be carried over in-home wireless networks, perhaps connected to an external network such as the Internet 303 via a home gateway 304. FIG. 3 illustrates an example of an in-home wireless IEEE 802.11-based multimedia network. The Basic Service Set (BSS) 301 carries mixed traffic consisting of both video and data. The access point (AP) 306 transmits two digital video streams, Video1 308.3 and Video2 308.1, as well as one data stream 308.2. Video1 308.3 is a multiple-layer video stream sent to station STA₅ 307.5, and Video2 308.1 is a single-layer video stream sent to station STA, 307.1. The data stream sent to station STA₂ 307.2 corresponds to an Internet session. Finally, station STA₄ 307.4 sends a multiple-layer video stream Video3 308/4 to station STA₃ 307.3.

In this illustrative example, the server 201 depicted in FIG. 2 is connected to an external network 303 such as the internet; the splitter 203 is contained within a home gateway 304; the adaptive transmission 205 comprising a plurality of transmission buffers 220 is performed by the AP 306; the channel bandwidth consists of the available amount allocated by an IEEE 802.11 network for Video1; and the reception, merger and client are contained within STA₅. Furthermore, the server, splitter and adaptive transmission are contained within STA₄; the channel bandwidth consists of the available amount allocated by the IEEE 802.11 network for Video3 308.4; and the reception, merger and client are contained within STA₃ 307.3.

A wireless IEEE 802.11 network 301 functions as a packet-switched network in which each transmitter acts as a node that stores network packets in a data buffer before sending them over the communication link; this is known as store-and-forward. A queuing discipline 402 determines the manner in which packets waiting to be transmitted are stored and the order in which they are subsequently transmitted. Fundamentally, a queuing discipline 402 includes of a classifier 502, one or more data buffers 503, and a scheduler 504, as illustrated in FIG. 5.

FIG. 4 illustrates how a queuing discipline is used for accepting different categories of incoming traffic 401 contained in data packets (e.g., video and data) and sending them as outgoing traffic 406 in data packets over a communication link.

Current state-of-the-art queuing disciplines such as WFQ (weighted fair queuing), CBWFQ (class-based weighted fair queuing), WRR (weighted round robin) and PQ (priority queuing), do not take advantage of the unique features of layered video and, as a result, can only achieve less-than-optimal efficiency. FIG. 5 illustrates priority queuing (PQ) as an example of a typical queuing discipline. The classifier 502 determines the category (i.e., C₁, C₂, or C₃) to which an incoming traffic packet 501 belongs, and stores it in the appropriate buffer, or queue 503. The scheduler 504 then selects packets according to priority from each of the three queues (one for each category) for transmission as outgoing traffic 508 over the communication link. In this queuing discipline, however, distinction is made only among the different categories of traffic packets (e.g., between video and data streams or between different streams of either type), but not among different layers of the same category. Furthermore, existing methods of selective packet adaptation for layered streaming media require modification of a device driver or even access to the device itself, or else require information from or knowledge about the wireless receiver. In the present invention, the determination of network conditions and available data bandwidth, and the actual dropping of ELs are contained entirely within the queuing discipline 505.

In a preferred embodiment, the present invention provides a queuing discipline 505 that adaptively selects data packets of one multiple-layer video stream for transmission in a manner that maximizes the number of EL packets transmitted while insuring the transmission of BL packets whenever possible.

The technique used in a preferred embodiment of the present invention for deciding when to drop EL packets is based on the principle that, if packets are stored in a buffer (queue) for transmission over the network, the average number of packets in the buffer over a period of time corresponds to the amount of network bandwidth available during that period. In particular, if the network is very congested or otherwise has a low available bandwidth, packets are stored in the buffer more rapidly than they are removed for transmission, and the average number of packets in the buffer will be large. If, on the other hand, the network is not congested and its full bandwidth is available, packets are removed from the buffer very quickly, and the average number of packets in the buffer will be small. The amount of data in this buffer serves as an indication of the available network bandwidth, and this in turn is used to determine whether to transmit or drop EL packets.

A preferred embodiment of a method of the present invention is a means for controlling the transmission of EL packets over a wireless network in a multiple-layer digital video streaming system. A block diagram of the buffer structures and queuing disciplines for such a method is illustrated in FIG. 6.

A series of thresholds is associated with transmission of packets from BL queue

D_THLD_ELᵢ

A_THLD_ELᵢ

for Elᵢ are determined for respectively dropping and adding packets to Elᵢ for the transmission process according to the following scheme.

Data packets to be transmitted are stored in a buffer that corresponds to the video stream layer to which the packet belongs (EL or BL), which is determined for each packet by the classifier 502. Under conditions of progressively lower available network bandwidth, Els 605.1-605.n are dropped, starting with the lowest-priority layer, followed by the second lowest-priority layer, and continuing in this manner through the highest-priority enhancement layer. The average number of packets in base-layer buffer BL 604 is used as a measure of available network bandwidth. If this number exceeds a threshold value D_THLD_Elₙ, the lowest-priority enhancement-layer packets are dropped from EL buffer ELₙ 605.n; this means that fewer data packets from the video steam are transmitted over the network, thereby alleviating network congestion and insuring that a higher percentage of the transmitted packets of the higher priority Els are received.

If dropping this enhancement layer brings the rate of transmitted packets below the limit imposed by the network bandwidth, the average number of packets in base-layer buffer BL 604 will not continue to grow, and may even decline. If it does grow beyond a second threshold value D_THLD_Elₙ₋₁, the second lowest-priority enhancement-layer packets are dropped from buffer ELₙ₋₁ 605.n−1. This is done for successively higher threshold values of the average number of packets in base-layer buffer BL 604, with each threshold D_THLD_ELₙ corresponding to a successively higher-priority enhancement-layer buffer ELₙ 605.n, until the threshold D_THLD_EL₁ for highest-priority layer buffer EL₁ is reached; at this point, all EL packets are dropped.

At some point, the average number of packets in the BL buffer will begin to decline as network conditions improve and the available bandwidth increases. When this number falls below threshold A_TH LD_El_{K}, corresponding to the highest-priority buffer EL_{K} that is currently not being transmitted (i.e., had previously been dropped), the transmission of packets from that EL is resumed. As the average number of packets in buffer BL continues to fall below successively lower threshold values A_THLD_Elₙ, each of which corresponds to a successively lower-priority enhancement-layer buffer ELₙ, the transmission of packets for that enhancement layer is resumed; this is done until threshold value A_THLD_Elₙ for lowest-priority buffer ELₙ is reached; at this point, all EL packets are once again transmitted.

For each enhancement-layer buffer ELₙ, base-layer buffer BL threshold value D_THLD_Elₙ for dropping packets is higher than threshold A_THLD_Elₙ for resuming transmission. This is done because digital video streams can be very “bursty”, in that there are times during which the number of data packets is very large, as well as times during which it is very small. To ensure that the first situation is not misinterpreted as a condition of degraded network bandwidth, the threshold value for dropping packets from a given enhancement layer must be set at a sufficiently high value. Conversely, the threshold value for resuming transmission from that enhancement layer must be low enough that the second situation above is not misinterpreted as a condition of improving network bandwidth. In any event, the former threshold value must be higher than the latter, and both threshold values increase monotonically with EL priority, so that:

D_THLD_Elₙ≧A_THLD_Elₙ

D_THLD_Elₙ₊₁≦D_THLD_Elₙ

A_THLD_Elₙ₊₁≦A_THLD_Elₙ

In a preferred embodiment, an actual dropping of enhancement-layer packets comprises two methods, depending upon the system requirements and implementation. In the first case, EL packets are dropped before being stored in their appropriate buffers (ELₙ). The enqueue policy is then controlled by the average number of packets in buffer BL 604, implemented by the classifier 502, which determines the buffer ELₙ 605.1-605.N that a packet belongs in, and comprises simply not writing any packets into the buffers for ELs that have been dropped. The dequeue policy for this case is one of sequentially reading every packet in every buffer, starting with BL buffer 604 and proceeding through all of the ELs in order of decreasing priority (i.e., starting with EL₁ 605.1 and finishing with ELₙ 605.n), and transmitting each packet immediately. The respective algorithms for the enqueue and dequeue policies corresponding to this discipline are given in the following pseudo-code segments:

Let

| | |
|---|---|
| current_buffer | denote the current (BL or ELₙ) buffer, |
| current_frame | denote the current video frame. |

| | |
|---|---|
| ENQUEUE: | /* Store the current incoming packet in queue */ |

Classify packet and select appropriate buffer (BL or ELₖ)
if buffer is active and not full

```
  store packet in buffer
  determine whether enhancement layer ELₙ packets need to be dropped
```

else

drop packet

| | |
|---|---|
| DEQUEUE: | /* Retrieve the next outgoing packet from queue */ |

do forever (loop):

| if front-of-queue packet in current_buffer belongs to current_frame | |
|---|---|
| breakout of loop | |
| else | /* proceed to next buffer */ |

if current_buffer is lowest-priority buffer (EL_{N})

set current_buffer to BL buffer
increment current_frame

else

set current_buffer to next lower-priority buffer (ELₙ₊₁)

determine whether enhancement layer ELₙ can be set active
retrieve and send front-of-queue packet from current_buffer

In a second preferred embodiment, every EL packet is stored in the appropriate buffer (ELₙ 605.n), but is not transmitted if it has been dropped. The enqueue policy then consists of writing every packet into the buffer ELₙ 605.n that it belongs in, as determined by the classifier. The dequeue policy, in this case, is controlled by the average number of packets in base-layer buffer BL 604, and consists of simply not reading any packets from the buffers for enhancement layers that have been dropped. This embodiment has the advantage of decreasing the latency between determination of a change in network bandwidth and the corresponding increase or decrease in the number of transmitted packets. The respective algorithms for the enqueue and dequeue policies corresponding to this discipline are given in the following pseudo-code segments:

| | |
|---|---|
| ENQUEUE: | /* Store the current incoming packet in queue */ |

Classify packet and select appropriate buffer (BL or ELₖ)
if buffer is full

drop packet

else

store packet in buffer
determine whether enhancement layer ELₙ packets need to be dropped

| | |
|---|---|
| DEQUEUE: | /* Retrieve the next outgoing packet from queue */ |

do forever (loop):

if front-of-queue packet in current_buffer belongs to current_frame

if current_buffer is active

/* found packet eligible for transmission */

break out of loop

else

/* found packet that needs to be dropped */

drop packet
continue next iteration of loop

else
/* proceed to next buffer */

if current_buffer is lowest-priority buffer (EL_{N})

set current_buffer to BL buffer
increment current_frame

else

set current_buffer to next lower-priority buffer (ELₙ₊₁)

determine whether enhancement layer ELₙ can be set active
retrieve and send front-of-queue packet from current_buffer

An alternative embodiment takes advantage of the fact that enhancement-layer packets are transmitted contiguously for a given enhancement layer, and these contiguous groups can in turn be transmitted in decreasing order of enhancement layer priority. That is, if an enhancement layer is lost, all enhancement layers that have a lower priority will be of no use to the receiver. Consequently, the transmission of enhancement-layer packets that are arranged in the above-described order can be truncated at any point within a video frame. The receiver 207 can then use all of the transmitted EL data to provide a level of video quality that is proportional to the amount of this data. The amount of data in turn corresponds to the truncation point, whose position can be chosen such that any desired number of EL packets from a given frame can be transmitted. This can be used as a mechanism for dropping an arbitrary number of EL packets in response to any amount of network bandwidth reduction, as determined by the average number of packets in the base layer buffer. It has the other advantage of requiring only two buffers, one for the BL packets and one for all of the EL packets. A block diagram 700 of the buffer structures 705 706 and queuing discipline 703 for this method is illustrated in FIG. 7.

In this alternative embodiment, the classifier 502 determines the layer to which each data packet belongs. Base-layer packets are stored in buffer BL 705. EL packets are stored in buffer EL 706, but must be arranged as contiguous groups for every EL, and these groups must in turn be organized in decreasing order of EL priority (i.e., for a given video frame, the contiguous group of EL packets for EL₁ is stored first, followed by the group for EL₂, etc., and the group for EL_{N} is stored last). Once again, the network bandwidth is determined from the average number of packets in buffer BL 705. If this number exceeds a threshold value THLD_1, a specified number of packets from the end of the enhancement-layer packet sequence are dropped. If the number of packets in buffer BL 705 exceeds a second, higher, threshold value THLD_2, a larger number of EL packets are dropped. The number of dropped EL packets increases monotonically with the largest exceeded average BL packet number threshold value THLD_n. Preferably, different threshold values are used for dropping a specified number of packets and for resuming the transmission of this same number, the former threshold value always being higher than the latter, to make this method more robust under conditions of bursty network data traffic.

Although a discrete number of threshold levels are depicted in the block diagram, the number of dropped packets can be implemented as a continuous monotonic function of the average number of packets in buffer BL 705. To make this alternative embodiment more robust under conditions of bursty network data traffic, this function is preferably further extended to be a continuous, monotonic hysteresis function, analogous to that for the magnetization of a ferromagnetic material with an applied magnetic field.

The dropping of EL packets reduces the number of packets transmitted over the network, alleviating network congestion and insuring that a higher percentage of the transmitted packets are received. Preferably, the queuing discipline comprises dropping these packets either before storage (enqueue) or after (dequeue). The respective algorithms for the enqueue and dequeue policies corresponding to these two disciplines are given in the following pseudo-code segments:

Let

| | |
|---|---|
| current_buffer | denote the current (BL or EL) buffer, |
| current_frame | denote the current video frame. |

| | |
|---|---|
| TN_EL_T | denote the number of EL packets from current_frame to be |

transmitted

| | |
|---|---|
| N_EL_T | denote the number of EL packets from current_frame |

already transmitted

Dropping enhancement-layer packets on enqueue

| | |
|---|---|
| ENQUEUE: | /* Store the current incoming packet in queue */ |

Classify packet and select appropriate buffer (BL or EL)
if buffer is full

drop packet

else

if buffer is BL buffer

store packet in buffer
calculate TN_EL_T
set N_EL_T = 0

else if (N_EL_T ≦ TN_EL_T)

store packet in buffer

increment N_EL_T

else

drop packet

| | |
|---|---|
| DEQUEUE: | /* Retrieve the next outgoing packet from queue */ |

do forever (loop):

| if front-of-queue packet in current_buffer belongs to current_frame | |
|---|---|
| | break out of loop |
| else | /* proceed to next buffer */ |

if current_buffer is EL buffer

set current_buffer to BL buffer
increment current_frame

else

set current_buffer to EL buffer

```
  retrieve and send front-of-queue packet from current_buffer
  if current_buffer is BL buffer
```

calculate TN_EL_T

Dropping enhancement-layer packets on dequeue

| | |
|---|---|
| ENQUEUE: | /* Store the current incoming packet in queue */ |

Classify packet and select appropriate buffer (BL or EL)
if buffer is full

drop packet

else

```
  store packet in buffer
  if buffer is BL buffer
```

calculate TN_EL_T

| | |
|---|---|
| DEQUEUE: | /* Retrieve the next outgoing packet from queue */ |

do forever (loop):

if front-of-queue packet in current_buffer belongs to current_frame

if current_buffer is BL buffer

break out of loop

else if (N_EL_T ≦ TN_EL_T)

break out of loop
increment N_EL_T

else

drop packet

| | continue next iteration of loop |
|---|---|
| else | /* proceed to next buffer */ |

if current_buffer is EL buffer

set current_buffer to BL buffer
increment current_frame
set N_EL_T to 0

else

set current_buffer to EL buffer

```
  retrieve and send front-of-queue packet from current_buffer
  if current_buffer is BL buffer
```

calculate TN_EL_T

As an example, FIG. 8 illustrates an actual streaming video system, FIG. 8 shows the operating system network stack on a server node that is also running one or more other applications, the stack comprising an application layer 812 and a kernel networking stack 802.

Each application sends data through a socket 803.i into the networking stack of the kernel where it is input to the socket buffer 804.i corresponding to that application. The data flows from different applications are subsequently multiplexed into the queuing discipline 805 for the networking device (e.g., a wireless transmitter). In this example, the queuing discipline 805 is a priority queue with two traffic categories, the first being the layered video stream sent by the streaming server, and the second being the data sent by the other applications. Once a networking packet has been associated with a traffic category by a classifier 806, it is inputted to a 2^{nd} tier queuing discipline. The 2^{nd} tier queuing discipline 807 for the layered video stream comprises the present invention, whereas the 2^{nd} tier queuing discipline for the remaining data traffic, in this case, makes use of a first-in-first-out (FIFO) methodology 808.

Referring now to FIG. 1B, in a preferred embodiment the system and method of the present invention provides priority class signalling for multiple video applications that are transmitted through the AP to one or more receivers. Each video application is associated with a unique receiving address and set of ports. A video application comprises multiple layers, each of which has a unique corresponding IP port number. Therefore, a video layer of a particular video application's flow is associated with a unique pair comprising an IP address and a port. This knowledge is possessed by the application layer, which can then build a table assigning each IP address/port pair to a priority and pass this table down to the DLL/MAC during application initialisation time, e.g. during admission control. The DLL/MAC of the underlying communication device receives this table and uses it to assign the priorities to each incoming packet based on the IP address/port information found in the IP packet.

While the preferred embodiments of the present invention have been illustrated and described, it will be understood by those skilled in the art that the management frame, device architecture and methods as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling with the scope of the appended claims.

1. An apparatus for adaptive transmission control of a video stream of a video application that includes a plurality of prioritized video packets having a plurality of priorities, the apparatus comprising:
a transmission side (212) comprising a plurality of transmission buffers (220) for storing said plurality of prioritized video packets;
an adaptive transmission component (205) comprising a mechanism for selective transmission/dropping of video packets determined by a pre-determined fullness threshold of at least one of the plurality of transmission buffers (220); and
a reception component (207) to receive the transmitted plurality of video packets of the video stream.

2. The apparatus of claim 1, wherein:
the plurality of transmission buffers (220) are a plurality of prioritized queues (503) corresponding to and for storing packets (402) (505) (805) of each prioritized packet in accordance with a predetermined enqueuing scheme (403) (502) (806); and
the adaptive transmission component (205) further comprises a mechanism to dequeue/drop an enqueued packet (606) (707) for transmission based on a pre-determined prioritized queue fullness scheme (610).

3. The apparatus of claim 2, wherein the predetermined enqueuing scheme (403) (502) (806) comprises storing prioritized video packets in a queue (404) (503) having a same pre-assigned priority.

4. The apparatus of claim 3, wherein said pre-assigned priority comprises at least a highest priority corresponding to visually important data and at least one lower priority corresponding to visually less important data.

5. The apparatus of claim 2, wherein the adaptive transmission component (205) further comprises the use of a fixed end-to-end delay for dequeuing the highest priority packets and a smaller end-to-end delay for dropping the lower priority packets.

6. The apparatus of claim 2, wherein:
the video stream further comprises at least one multi-layer video stream (100) (204) corresponding to a video application, each said layer corresponding to a priority of said plurality of priorities;
the adaptive transmission component (205) further comprises aggregated transmission control for the plurality of multi-layer video streams (100) including—
i. the application of a different retry limit to at least one of said plurality of prioritized queues,
ii. the application of a different transmission rate to at least one of said plurality of prioritized queues, and
iii. if a transmission queue exceeds a pre-determined threshold for fullness, drop a pre-determined number of lower priority packets from the transmission queue such that the transmission queue no longer exceeds the pre-determined threshold for fullness regardless of the video application each packet is associated with.

7. The apparatus of claim 6, wherein:
a priority is associated with each layer of each video application by assigning a priority to a unique pair of IP address and port number derived from a unique receiving address of the video application sending the layer and the unique corresponding internet protocol (IP) port number of the layer; and
said pre-assigned priority is determined by a table passed down to a data link layer/MAC (154/155) during the video application initialization time, said table comprising the unique pair of IP address and port number of each video layer.

8. The apparatus of claim 7, wherein the adaptive transmission component (205) maintains a historical dropping ratio of lower priority packets for each video application and a lower priority packet of one video application is not dropped if the historical dropping ratio of the one application exceeds a dropping ratio of another video application by a predetermined dropping threshold.

9. The apparatus of claim 2, wherein:
the video stream further comprises at least one multi-layer video stream (100) (204) corresponding to a video application;
said plurality of prioritized queues (220) is maintained independently for each video application; and
the adaptive transmission component (205) further comprises independent transmission control for each of the plurality of multi-layer video streams (204) including—
i. the application of a different retry limit to at least one of said plurality of prioritized queues (220), and
ii. the application of a different transmission rate to at least one of said plurality of prioritized queues (220),
as well as aggregated transmission control such that there is a single transmission queue and if the single transmission queue exceeds a predetermined threshold for fullness, a pre-determined number of lower priority packets are dropped from the transmission queue such that the transmission queue no longer exceeds the pre-determined threshold for fullness regardless of the video application each packet is associated with.

10. The apparatus of claim 9, wherein:
a priority is associated with each layer (101) 102) of each video application by assigning a priority to a unique pair of IP address and port number derived from a unique receiving address of the video application sending the layer and the unique corresponding internet protocol (IP) port number of the layer; and
said pre-assigned priority is determined by a table passed down to a data link layer/MAC (154/155) during the video application initialization time, said table comprising the unique pair of IP address and port number of each video layer.

11. The apparatus of claim 10, wherein the adaptive transmission component (205) maintains a historical dropping ratio of lower priority packets for each video application and a lower priority packet of one video application is not dropped if the historical dropping ratio of the one application exceeds a dropping ratio of another video application by a pre-determined dropping threshold.

12. The apparatus of claim 2, wherein the prioritized queue fullness scheme (610) (703) comprises a means for deciding whether or not to drop or add transmission of packets of a layer such that transmission of packets having a higher priority is maximized.

13. The apparatus of claim 12, wherein the prioritized queue fullness scheme (610) (703) is based, in part, on the principle that if packets are stored in a queue for transmission the average number of packets in the queue over a period time corresponds to the amount of network bandwidth available during that period.

14. The apparatus of claim 13, wherein:
the plurality of layers (204) and corresponding queues (205) comprises a base layer (BL) (101) and corresponding BL queue (604) (705) having a highest priority and at least one enhancement layer i (ELᵢ) (102.i) and corresponding ELᵢ queue (605.i) (706) having a pre-determined lower priority;
the prioritized fullness scheme further comprises a series of thresholds for each ELᵢ queue (610)
D_THLD_ELᵢ for dropping packets from ELᵢ
A_THLD_ELᵢ for adding packets from ELᵢ
used to determine when an average number of packets in the BL queue (604) exceeds D_THLD_ELᵢ such that packets in the enhancement layer queue ELᵢ (605.i) are dropped, and the average number of packets in the BL queue (604) falls below A_THLD_ELᵢ and packets in the enhancement queue ELᵢ (605.i) are added.

15. The apparatus of claim 14, wherein both threshold values increase monotonically with EL priority so that
D_THLD_Elᵢ≧A_THLD_Elᵢ
D_THLD_Elᵢ₊₁≦D_THLD_Elᵢ.
A_THLD_Elᵢ₊₁≦A_THLD_Elᵢ;

16. The apparatus of claim 15, wherein the dropping of EL packets is done by a technique selected from the group consisting of
i. dropping an EL packet before it is enqueued, and
ii. enqueuing an EL packet but not dequeuing any packets for transmission for Els that have been dropped.

17. The apparatus of claim 13, wherein:
the plurality of layers (204) and corresponding queues (220) comprises a base layer (BL) (101) and corresponding BL queue (705) having a highest priority and at least one enhancement layer i (ELᵢ) (102.i) and one combined EL queue (706) having a lower priority;
the prioritized fullness scheme further comprises a series of thresholds for each ELᵢ (102.i)
D_THLD_i for dropping a predetermined number of packets from the EL queue (706)
A_THLD_i for resuming transmission of the same pre-determined number of packets from the EL queue (706)
used to determine when an average number of packets in the BL queue (705) exceeds D_THLD_i such that the pre-determined number of packets at the end of the enhancement layer queue EL (706) are dropped or when the average number falls below A_THLD_i the same predetermined number of packets are added at the end of queue EL (706).

18. The apparatus of claim 17, wherein threshold values increase monotonically with EL priority so that
D_THLD_i≧A_THLD_i
D_THLD_i≧D_THLD_i+1
A_THLD_i≧A_THLD_i+1.

19. A system for adaptive transmission control of at least one multi-layered video stream (204) of a video application of a plurality of applications, comprising a server (201) including an operating system network stack comprising:
i. an application layer (812); and
ii. a kernel networking stack (802) including a queuing discipline (805) comprising the apparatus of claim 11 (205) for adaptive transmission control of the at least one multi-layered video stream (204).

20. A system for adaptive transmission control of at least one multi-layered video (204) stream of a video application of a plurality of applications, comprising a server (201) including an operating system network stack comprising:
i. an application layer (812); and
ii. a kernel networking stack (802) including a queuing discipline (805) comprising the apparatus of claim 14 for adaptive transmission control (205) of the at least one multi-layered video stream (204).

21. A layered video transmission system, comprising:
a server (201) for transmitting a single layer video stream (202);
a splitter (203) that creates a video stream having multiple layers (204) comprising at least one base layer (101) and at least one enhancement layer (102.i) from the single layer video (202); and
an adaptive transmission component (205) comprising an apparatus selected from the group consisting of
the apparatus of claim 14, and
the apparatus of claim 17,
for transmission of the multilayer video stream (204);
a reception module (207) for receiving the transmitted multi-layer video stream (213); and
a merger module (209) that merges the received multiple layers (208) to output a merged image to a client (211).

22. The system of claim 21, wherein a first wireless device (307.4) comprises the server, splitter and adaptive transmission component and a second wireless device (307.3) is the client and includes the reception module, merger module.

23. The system of claim 22, wherein the first wireless device (307.4) and the second wireless device (307.4) is a station of an IEEE 802.11 basic service set (BSS).

24. The system of claim 21, wherein:
said server (201) is connected to an external network (303); and
said system further comprises:
i. a gateway node including the splitter (304),
ii. a wireless network (301) having an access point (306) that includes the adaptive transmission component and at least one station (307.i) configured as a client (211) and to include the reception (207) and merger modules (209).

25. The system of claim 24, wherein the external network (303) is the Internet and the wireless network (301) is an IEEE 802.11 basic service set (BSS).

26. A method for adaptively controlling transmission of a video stream (204) of a video application that includes a plurality of prioritized video packet layers, comprising the steps of:
providing a plurality of prioritized queues (220) wherein said priority comprises a highest and at least one lower priority corresponding to visually important data and visually less important data (100);
enqueuing (403) (502) (603) (704) (806) each of the prioritized packets in a queue (220) having a same pre-assigned priority;
dequeuing (405) (504) (606) (807) an enqueued packet for transmission based on a pre-determined prioritized queue fullness scheme (610) (703).

27. The method of claim 26, wherein the dequeuing step (405) (504) (606) (807) comprises the step of using a fixed end-to-end delay for dequeuing the highest priority packets and a smaller end-to-end delay for dropping the lower priority packets.

28. The method of claim 27, wherein:
the video stream (204) further comprises at least one multi-layer video stream (204) corresponding to a video application;
the dequeuing step (405) (504) (606) (807) further comprises aggregated transmission control for the plurality of multi-layer video streams by performing at least one of the steps of—
i. applying a different retry limit to at least one of said plurality of prioritized queues,
ii. applying of a different transmission rate to at least one of said plurality of prioritized queues, and
iii. when a transmission queue exceeds a pre-determined threshold for fullness, dropping a pre-determined number of lower priority packets from the transmission queue such that the transmission queue no longer exceeds the pre-determined threshold for fullness regardless of the video application each packet is associated with.

29. The method of claim 28, further comprising the steps of
associating a priority with each layer of each video application by assigning a priority to a unique pair of IP address and port number derived from a unique receiving address of the video application sending the layer and the unique corresponding internet protocol (IP) port number of the layer,
building a table of unique pairs of IP address and port number of each video layer;
passing the table down to a datalink layer/MAC (154/155) during the video application initialization time; and
determining said pre-assigned priority using the table passed down.

30. The method of claim 29, further comprising the steps of:
maintaining a historical dropping ratio of lower priority packets for each video application;
when the historical dropping ratio of a first application exceeds a dropping ratio of other video applications by a pre-determined dropping threshold, retaining lower priority packets of the first application.

31. The method of claim 26, wherein:
the video stream further comprises at least one multi-layer video stream (204) corresponding to a video application;
independently maintaining said plurality of prioritized queues (220) for each video application; and
the dequeuing step (405) (504) (606) (807) further comprises the steps of independently controlling each of the plurality of multi-layer video streams by performing the steps of—
i. applying a different retry limit to at least one of said plurality of prioritized queues, and
ii. applying a different transmission rate to at least one of said plurality of prioritized queues,
iii. when the single transmission queue exceeds a pre-determined threshold for fullness, a pre-determined number of lower priority packets are dropped from the transmission queue such that the transmission queue no longer exceeds the pre-determined threshold for fullness regardless of the video application each packet is associated with.

32. The method of claim 31, further comprising the steps of:
associating a priority with each layer of each video application by assigning a priority to a unique pair of IP address and port number derived from a unique receiving address of the video application sending the layer and the unique corresponding internet protocol (IP) port number of the layer;
building a table of unique pairs of IP address and port number of each video layer;
passing the table down to a datalink layer/MAC 154/155) during the video application initialization time; and
determining said pre-assigned priority using the table passed down.

33. The method of claim 32, further comprising the steps of:
maintaining a historical dropping ratio of lower priority packets for each video application;
when the historical dropping ratio of a first application exceeds a dropping ratio of other video applications by a pre-determined dropping threshold, retaining lower priority packets of the first application.

34. The method of claim 26, further comprising the step of deciding whether or not to drop or add transmission of packets of a layer such that transmission of packets having a higher priority is maximized.

35. The method of claim 34, wherein the deciding step is based, in part, on the principle that if packets are stored in a queue for transmission the average number of packets in the queue over a period time corresponds to the amount of network bandwidth available during that period.

36. The method of claim 26, wherein:
the providing step further comprises the step of providing the plurality of layers (204) and corresponding queues (220) as a base layer (BL) (101) and corresponding BL queue (604) (705) having a highest priority and at least one enhancement layer i (EL) (102.i) and corresponding EL queue (605.i) (706) having a pre-determined lower priority;
the dequeuing further comprises the steps of:
i. assigning a series of thresholds for each ELᵢ queue (605.i) (706)
D_THLD_ELᵢ for dropping packets from ELᵢ (605.i) (706)
A_THLD_ELᵢ for adding packets from ELᵢ (605.i) (706),
ii. when an average number of packets in the BL queue (604) (705) exceeds D_THLD_ELᵢ dropping packets in the enhancement layer queue ELᵢ (605.i) (706), and
iii. when the average number of packets in the BL queue (604) (705) falls below A_THLD_ELᵢ adding packets in the enhancement queue ELᵢ (605.i) (706).

37. The method of claim 36, wherein both threshold values increase monotonically with EL priority so that
D_THLD_Elᵢ≧A_THLD_ELᵢ
D_THLD_Elᵢ₊₁≦D_THLD_Elᵢ.
A_THLD_Elᵢ₊₁≦A_THLD_ELᵢ

38. The method of claim 36, wherein the step of dropping of EL packets further comprising performing a step selected from the group consisting of—
i. dropping an EL packet before it is enqueued, and
ii. enqueuing an EL packet but not dequeuing any packets for transmission for Els that have been dropped.

39. The method of claim 26, wherein:
the providing step further comprises the step of providing the plurality of layers and corresponding queues as a base layer (BL) (1101) and corresponding BL queue (604) (705) having a highest priority and at least one enhancement layer i (ELᵢ) (102.i) and corresponding ELᵢ queue (605.i) (706). having a pre-determined lower priority;
the dequeuing further comprises the steps of:
i. assigning a series of thresholds for each ELᵢ queue (605.i) (706).
D_THLD_i for dropping a pre-determined number of packets from the EL queue (605.i) (706).
A_THLD_i for resuming transmission of the same predetermined number of packets from the EL queue (605.i) (706).
ii. when an average number of packets in the BL queue (604) (705) exceeds D_THLD_i dropping a predetermined number of packets at the end of the enhancement layer queue EL (605.i) (706), and
iii. when the average number of packets in the BL queue (604) (705) falls below A_THLD_i adding the same predetermined number of packets at the end of the enhancement queue EL. (605.i) (706).

40. The method of claim 39, wherein threshold values increase monotonically with EL priority so that
D_THLD_i≧A_THLD_i
D_THLD_i≧D_THLD_i+1
A_THLD_i≧A_THLD_i+1.
